(19) United States
(12) Patent Application Publication
(10) Pub. No.: US 2025/0043583 A1
(43) Pub. Date: Feb. 6, 2025

(54) MULTIFUNCTIONAL POLE

(71) Applicant: NEC Corporation, Minato-ku, Tokyo (JP)

(72) Inventors: Kazuki OGATA, Tokyo (JP); Toshihiro WATANABE, Tokyo (JP); Hitomi ITO, Tokyo (JP); Taiki NAKAMURA, Tokyo (JP)

(73) Assignee: NEC Corporation, Minato-ku, Tokyo (JP)

(21) Appl. No.: 18/719,909

(22) PCT Filed: Dec. 23, 2021
(86) PCT No.: PCT/JP2021/048005

§ 371 Date: Jun. 14, 2024

(51) Int. Cl. E04H 12/18; F21S 8/08; G08G 1/095

(52) U.S. Cl. CPC E04H 12/18; F21S 8/086; G08G 1/095

(57) ABSTRACT

A multifunctional pole includes two or more units selected from among a plurality of units each providing a predetermined function. In the multifunctional pole, the two or more units are coupled to each other to form the pole.

### TECHNICAL FIELD

The present disclosure relates to a multifunctional pole.

### BACKGROUND ART

As related art, Patent Literature 1 discloses a pole to which a device can be attached. The pole disclosed in Patent Literature 1 includes a cylindrical support pillar and one or more coupling poles. The coupling pole includes a cylindrical body. The cylindrical body includes a first connection part provided at one end thereof in the longitudinal direction, a second connection part provided at the other end thereof in the longitudinal direction, and a device attachment part to which a device is attached. The first connection part of each of the coupling poles is configured to be connectable to the second connection part of another coupling pole. The support pillar includes a fixed part provided at one end thereof in the longitudinal direction and a third connection part provided at the other end thereof in the longitudinal direction. The third connection part is configured to be connectable to the first connection part or the second connection part of the coupling pole.

In Patent Literature 1, the fixed part of the support pillar includes a base plate. The base plate is fixed to a foundation provided on the ground using a fixing bolt. For example, the second connection part of the coupling pole is connected to the third connection part of the support pillar, and the coupling pole is connected on to the support pillar. On the coupling pole connected to the support pillar, any number of coupling poles may be connected by connecting the first connection part of one coupling pole to the second connection part of another coupling pole. A device such as a lighting fixture, a security camera, a speaker, or an automatic flashing device may be attached to the device attachment part of each coupling pole.

### CITATION LIST

### Patent Literature

Patent Literature 1: Japanese Unexamined Patent Application Publication No. 2019-190002

### SUMMARY OF INVENTION

### Technical Problem

In Patent Literature 1, the total length of the pole can be changed by changing the number of coupling poles attached on to the support pillar. For example, the total length of the pole can be increased by increasing the number of coupling poles, and the total length of the pole can be reduced by reducing the number of coupling poles. Further, the coupling pole includes the device attachment part, and a device attached to the device attachment part of each coupling pole can be freely changed.

However, according to Patent Literature 1, the device is separate from the coupling pole, and the device is externally attached to the body of the coupling pole. According to Patent Literature 1, as the number of devices attached to the body of the coupling pole increases, it starts to have a cluttered appearance. For example, when the above pole is installed in a park or the like, the pole does not harmonize with the landscape in a place where it is installed, and hence the pole may spoil the landscape. Further, according to Patent Literature 1, there is a problem that a user needs to prepare a device that can be attached to the device attachment part of the coupling pole in addition to the coupling pole.

In view of the above-described circumstances, an object of the present disclosure is to provide a multifunctional pole that can have several functions without it having a cluttered appearance.

### Solution to Problem

To achieve the above object, the present disclosure provides a multifunctional pole as a first example aspect. The multifunctional pole includes a plurality of units, each of the plurality of units having a predetermined function, in which the plurality of units are coupled to each other to form the pole.

### Advantageous Effects of Invention

The multifunctional pole according to the present disclosure can have several functions without it having a cluttered appearance.

### BRIEF DESCRIPTION OF DRAWINGS

FIG. 1 is a diagram showing a multifunctional pole according to the present disclosure;

FIG. 2A is a front view showing a multifunctional pole according to an example embodiment of the present disclosure;

FIG. 2B is an exploded perspective view showing a multifunctional pole according to an example embodiment of the present disclosure;

FIG. 3 is an exploded perspective view showing an example of a configuration of a module for a traffic signal;

FIG. 4 is a perspective view showing a module that may be used in the multifunctional pole;

FIG. 5 is a front view showing a multifunctional pole according to a first modified example;

FIG. 6 is a front view showing a multifunctional pole according to a second modified example; and

FIG. 7 is a front view showing a multifunctional pole according to a third modified example.

### EXAMPLE EMBODIMENT

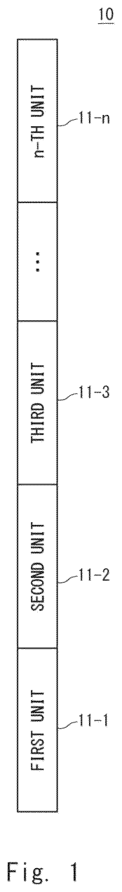

Prior to describing example embodiments of the present disclosure, an outline of the present disclosure will be described. FIG. 1 shows a multifunctional pole according to the present disclosure. A multifunctional pole 10 includes a first unit 11-1 to an n-th unit 11-n (n is an integer of two or greater). Each of the first unit 11-1 to the n-th unit 11-n is configured as a unit having a predetermined function. Note that the first unit 11-1 to the n-th unit 11-n are also referred to as units 11 when it is not particularly necessary to distinguish them from each other.

In FIG. 1, the n units 11-1 to 11-n are coupled to each other to form the multifunctional pole 10. The units 11-1 to 11-n may include a unit including a traffic signal. Alternatively or in addition, the units 11-1 to 11-n may include at least one of a unit including a radio communication device that performs radio communication with a radio communication terminal, a unit including a camera that captures an image of an area near the multifunctional pole 10, a unit including a sensor, and a unit including an illumination lamp. In the multifunctional pole 10, the order of the n units 11-1 to 11-n may be configured to be appropriately changeable. The n units 11-1 to 11-n are not required to have functions different from each other, and the multifunctional pole 10 may include two or more units 11 having the same function.

In the present disclosure, the multifunctional pole 10 includes a plurality of units 11 each having a predetermined function. When the plurality of units 11 are coupled to each other, they collectively form a body of the pole. In the present disclosure, the units 11 to be coupled to each other are appropriately selected, whereby the multifunctional pole 10 may provide various types of functions. In the present disclosure, the multifunctional pole is formed by coupling a plurality of units to each other each having a predetermined function instead of attaching a device having a predetermined function thereto. Therefore, unlike the case in which a plurality of external devices are attached to the pole, the present disclosure can be harmonized with the landscape without it having a cluttered appearance.

The example embodiments according to the present disclosure will be described hereinafter in detail with reference to the drawings. Note that, for the clarification of the description, the following descriptions and the drawings are partially omitted and simplified as appropriate. Further, the same elements and similar elements are denoted by the same reference symbols throughout the drawings, and redundant descriptions are omitted as necessary.

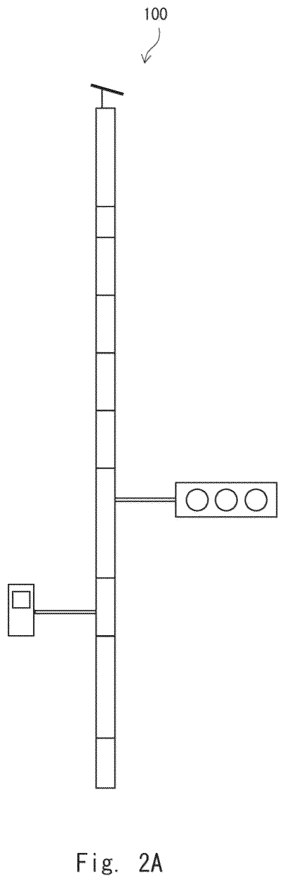

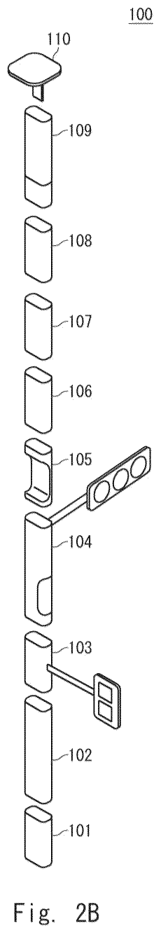

Each of FIGS. 2A and 2B shows a multifunctional pole according to an example embodiment of the present disclosure. In the example embodiment, the multifunctional pole constitutes a traffic signal 100. FIG. 2A is a front view of the traffic signal 100 when viewed from the front thereof, while FIG. 2B is an exploded perspective view of the traffic signal 100 when viewed from the oblique direction. The traffic signal 100 includes a plurality of modules 101 to 109 coupled to each other. Each of the modules 101 to 109 may also be referred to as a unit or an assembly (ASSY). The traffic signal 100 corresponds to the multifunctional pole 10 shown in FIG. 1, and the modules 101 to 109 correspond to the units 11.

The module 101 is, for example, a module constituting a shared unit. The module 101 includes therein devices such as a power supply apparatus and a network apparatus. The power supply apparatus supplies power to devices mounted on the modules 101 to 109. The module 101 may include a power meter for monitoring the amount of power consumed by each component in the traffic signal 100. The module 101 may include, for example, a power meter for monitoring the amount of power consumed by each unit. The network apparatus is connected to an external network. The devices mounted on the modules 102 to 109 may be configured so that they can communicate with the external network through the network apparatus of the module 101. The module 101 may, for example, be at least partially embedded in the ground. However, it is not particularly limited thereto. Alternatively, the module 101 may be coupled to a foundation disposed in the ground using a fastening bolt and the like. The module 101 may be coupled to a support pillar embedded in the ground.

It is considered here that the module 101 constituting a shared unit is heavy since it includes an apparatus such as a power supply apparatus. When the center of gravity is taken into account, it is considered that the module 101 is preferably disposed at a low position in the traffic signal 100. However, the position of the module 101 in the traffic signal 100 is not particularly limited to a low position. The module 101 may be disposed at a position slightly above the ground. For example, when the module 101 is disposed at a low position, the module 101 may be submerged when a flood or the like has occurred. When the traffic signal 100 is installed at a point where a flood may occur, the module 101 may be disposed in the traffic signal 100 at a position higher than the water level assumed in the event of a flood.

The module 102 is, for example, a module having a function of digital signage. The module 102 includes, for example, a display and a control unit (controller). The module 102 may include a speaker and a microphone. The module 102 may further include an edge computer (Multi-access/Mobile Edge Computing (MEC) server).

The modules 103 and 104 are modules each having a function of a traffic signal. The module 103 is a module having a function of a traffic signal for pedestrians. The module 104 is a module having a function of a traffic signal for vehicles.

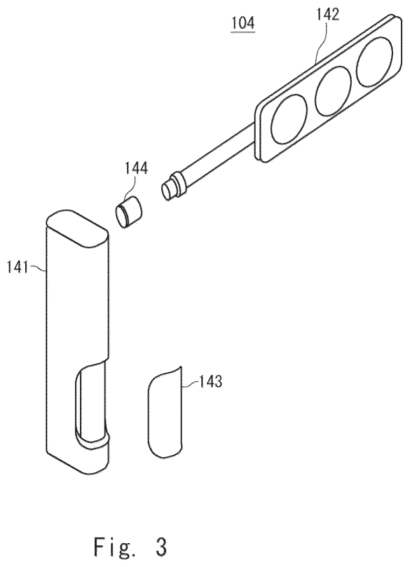

FIG. 3 shows a configuration example of the module 104. The module 104 includes a body 141 and a traffic signal lighting device 142. The traffic signal lighting device 142 includes blue, yellow, and red lamps. The body 141 includes an attachment to which an attachment tool 144 is attached. The arm of the traffic signal lighting device 142 is attached to the body 141 through the attachment tool 144. In the module 104, the body 141 may include a plurality of attachments to which the attachment tool 144 is attached. For example, the body 141 may include one attachment on each of the four sides thereof. The body 141 may include therein a camera that is used to control the traffic signal lighting device. A transparent cover 143 for protecting the camera may be attached to the body 141.

The module 104 may include a signal lighting device control circuit that controls the traffic signal lighting device 142 inside the body 141. The signal lighting device control circuit is not necessarily be disposed in the module 104, and may be disposed in another module. Further, the signal lighting device control circuit is not necessarily be disposed in one of modules of the traffic signal 100. For example, the signal lighting device control circuit may be disposed outside the traffic signal 100. In this case, the signal lighting device control circuit may communicate with the module 104 through a network and control the traffic signal lighting device 142 through the network.

Note that a configuration of the module 103 having the function of a traffic signal for pedestrians may be similar to that of the module 104 except that the traffic signal lighting device is used for pedestrians. Four attachments to which a traffic signal lighting device for pedestrians can be attached thorough the attachment tool may be provided in the module 103, and the direction of the traffic signal lighting device for pedestrians may be determined by appropriately selecting a position where it is attached. Similarly, in the module 104, a plurality of attachments may be provided on the body thereof, and the direction of the traffic signal lighting device 142 may be selectable.

Note that the module 103 and the module 104 are not necessarily be separated from each other. The module 103 and the module 104 may be configured as a single module. Further, the module 103 and the module 104 may be configured as a common module that can be used as either one of the modules. In this case, either a traffic signal lighting device for vehicles or a traffic signal lighting device for pedestrians may be selectively connected to the common module. In this case, a control apparatus corresponding to the traffic signal lighting device to be connected may be disposed in the common module.

The module 105 is a module having a function of a security camera. The module 105 includes, for example, a camera that captures an image of an area near the traffic signal 100 and a camera control circuit. The modules 106 and 107 are modules for adjusting the height or the length of the pole. The modules 106 and 107 are not required to include therein functional units. For example, the inside of each of the modules 106 and 107 may be hollow.

The module 108 is a module having a function of a public WiFi (registered trademark) base station. The module 108 includes, for example, a radio antenna and a WiFi transceiver (a radio communication apparatus). The module 109 is a module having a function of a 5th Generation (5G) antenna base station. The module 109 includes, for example, a radio antenna and a 5G transceiver (a radio communication apparatus). The communication system of the radio communication function included in the traffic signal 100 is not limited to 5G and public WiFi. The traffic signal 100 may include a module including a radio communication apparatus of a communication system such as Multi-Channel Access (MCA) Advance or Cellular V2X (Vehicle to X) (C-V2X). In the traffic signal 100, a module 110 including therein a module that generates power from renewable energy, for example, a solar panel, is attached on to the module 109. The radio communication is not limited to 5G, and may instead be radio communication conforming to a next generation communication standard. The traffic signal 100 may include a module including a radio communication terminal instead of or in addition to a module including a function of a radio base station.

In the traffic signal 100, it is assumed that a region having a predetermined height from the ground, e.g., a region having a height from the ground of 5.5 m, is a region used by traffic-related ministries and agencies, e.g., the transportation authority. In the traffic signal 100, the modules 102, 103, 104, and 105 are disposed in a region used by the transportation authority. In the traffic signal 100, it is assumed that a region having a height greater than 5.5 m is an open region that can be used by authorities other than the transportation authority. Private companies, municipalities, and national organizations other than the transportation authority may install any module in the open region. In the traffic signal 100, the modules 108 and 109 are disposed in the open region.

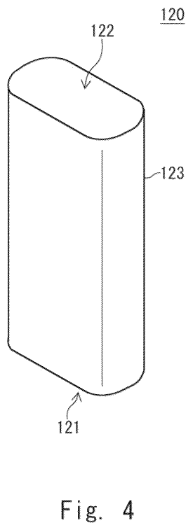

FIG. 4 shows a module that may be used as the modules 101 to 109. A module 120 includes a cylindrical body 123. The body 123 is formed of a material such as metal. The body 123 may be formed of a various types of materials depending on the strength required for the module and the weight allowed for the module. For example, a module that is expected to be installed at a high position in the traffic signal 100 may be formed of a light material such as carbon fiber.

The module 120 may include inside the body 123 a device for providing a predetermined function. The cross-sectional shape of the module 120 in a plane perpendicular to the longitudinal direction may be elliptical or oblong. However, it is not limited to a particular shape. When the cross-sectional shape is elliptical or oblong, a device can be accommodated more efficiently than when it is circular. Further, an impression of the appearance can be improved. The lengths of the respective modules (the length of the pole in the longitudinal direction) may be different from each other or the same as each other.

The module 120 includes a first interface 121 at one end thereof in the longitudinal direction and a second interface 122 at the other end thereof in the longitudinal direction. Each of the first interface 121 and the second interface 122 includes, for example, a power supply terminal for supplying power. Alternatively or in addition, each of the first interface 121 and the second interface 122 includes a communication terminal for signal communication. A plurality of modules may be coupled by connecting the first interface 121 of one module (a first module) 120 to the second interface 122 of another module (a second module) 120. A plurality of modules 120 are coupled to each other and terminals of the first interfaces 121 are connected to terminals of the second interfaces 122, whereby the module 101 constituting a shared unit may be electrically connected to each of the modules 102 to 109 located above the module 101.

The first module (its first interface) may be directly connected to the second module (its second interface). Alternatively, the first interface may be connected to the second interface through a connection member for connecting them to each other. In this case, the connection member may have a function of bypassing a power supply terminal and a function of bypassing a signal communication terminal, and the modules may be electrically connected to each other through the connection member.

Note that the order of the modules 101 to 109 shown in FIG. 2B is an example, and the order of the modules in the traffic signal 100 is not limited to a particular order. Each of the modules includes the first interface 121 and the second interface 122, and the order of the modules in the traffic signal 100 can be freely changed. Further, in the traffic signal 100, the module disposed at the lowest position only needs to include the second interface 122 and may not include the first interface 121.

For example, the traffic signal 100 has a function of providing information to nearby people by using digital signage in addition to the function of a normal traffic signal. For example, an edge computer included in the module 102 acquires a video image from a camera included in the module 105 and analyzes the camera video image. For example, the edge computer analyzes whether or not there is a person who needs support at the intersection where the traffic signal 100 is installed. When there is a person who needs support, the edge computer supports the person by using digital signage (display). When the traffic signal 100 includes a Roadside Unit (RU) that provides V2I (vehicle to infrastructure) communication with a vehicle, the edge computer may notify nearby vehicles through the RU that there is a person who needs support. Although an example in which the module 102 includes an edge computer has been described in this example embodiment, another module may include therein an edge computer, or a module including therein only an edge computer may be present.

The edge computer may analyze the camera video image and analyze (i.e., determine) whether or not an accident, an incident, or a disaster has occurred near the intersection where the traffic signal 100 is installed. When the edge computer determines that an accident, an incident, or a disaster has occurred, it may automatically report it to the related organizations. Further, the edge computer may display a place where an Automated External Defibrillator (AED) is installed on the digital signage and notify nearby people about the place where the AED is installed. When the edge computer determines that a disaster has occurred, it may display an evacuation shelter on the digital signage and guide nearby people to the evacuation shelter.

In this example embodiment, the pole of the traffic signal 100 is formed by appropriately combining a plurality of the modules 101 to 109 with each other. Each of the modules has a predetermined function, and various types of functions can be added to the traffic signal 100 by appropriately selecting modules to be used as the pole of the traffic signal 100. In this example embodiment, the modules 101 to 109 that form the pole have functions provided by the traffic signal 100. Therefore, as compared to a case where various types of devices are attached to the pole, the traffic signal 100 can give an impression that does not clash with a streetscape and is tidy in an already-cluttered landscape including a utility pole and the like.

In this example embodiment, the multifunctional pole constituting a traffic signal may be formed by combining required modules in accordance with an installation place and required functions. For example, assume a case in which four traffic signals are installed at one intersection. One of the four traffic signals includes a module having a function of a security camera and a module having a function of a public WiFi base station in addition to a module having a function of a traffic signal. The remaining three traffic signals include a module having a function of a traffic signal, but do not include a module having a function of a security camera and a module having a function of a public WiFi base station. Like in this example, one of the four traffic signals may be a multifunctional traffic signal, and the remaining three traffic signals may be traffic signals each having a simple configuration.

Alternatively, when four traffic signals are installed at one intersection, one of the four traffic signals may be a traffic signal including a module having a function of a radio base station, and the remaining three traffic signals may be traffic signals each including a module including a radio communication terminal. In this case, the traffic signal including a module including a radio communication terminal can perform radio communication with the traffic signal including a module having the function of a radio base station.

Further, at each of a plurality of intersections, one of traffic signals disposed at the intersection may be a multifunctional traffic signal such as the traffic signal 100. For example, one of the four existing traffic signals installed at each of the plurality of intersections may be replaced by the traffic signal 100. In this case, the traffic signal 100 installed at one intersection can perform radio communication with the traffic signals 100 installed at other intersections within a range in which such communication can be performed. In this case, information can be exchanged among the traffic signals at the plurality of intersections.

Note that, in the above example embodiment, it is not required for each module to include, in a single module, all the circuit and the control unit required for the functions to be provided. For example, the signal lighting device control circuit that controls the traffic signal lighting device for vehicles and the traffic signal lighting device for pedestrians in the traffic signal 100 may be disposed in the module 101 which is a shared unit. In this case, the signal lighting device control circuit can be disposed at a position lower than the position of each of the modules 103 and 104, whereby maintenance work and other operations can be easily performed. Alternatively, a 5G Radio Unit (RU), a Distributed Unit (DU), a Centralized Unit (CU), and antennas may be distributed in several modules in a distributed manner, and these modules may operate together to thereby provide a function of 5G radio communication in the traffic signal 100.

In the above example embodiment, the thicknesses of the modules (the sizes and the shapes of the modules in a plane perpendicular to the longitudinal direction) may be the same as each other or different from each other. In a case in which the thicknesses of the modules are the same as each other, the thickness of the traffic signal 100 (the multifunctional pole) becomes uniform when the modules are coupled to each other, and hence the appearance thereof is good. Further, the degree of flexibility in changing the combination (the heights) of the modules is increased. For example, a desired height of the camera may vary depending on the location where the traffic signal 100 is installed. In a case in which the thicknesses of the modules are the same as each other, the position of the module including a camera in the traffic signal may be freely changed, and thus the module including the camera can be disposed at a position at any height.

One pole may be formed by coupling modules having a plurality of thicknesses to each other. For example, the traffic signal 100 may include several modules each having a first thickness, several modules each having a second thickness, and several modules each having a third thickness. In this case, it is assumed that a module having the first thickness is the thickest module, a module having the third thickness is the thinnest module, and a module having the second thickness is the module having a thickness intermediate between those of the first two modules. In the traffic signal 100, a module having the first thickness may be disposed at the lower part, a module having the second thickness may be disposed at the intermediate part, and a module having the third thickness may be disposed at the upper part. That is, the traffic signal 100 may have such a structure that the lower part thereof is the thickest and the thickness thereof tapers upwardly. In this case, the order of the modules may be switchable among the modules having the same thickness. It is advantageous in regard to strength and stability to dispose a thick module at the lower part of the traffic signal 100 and a thin module at the upper part thereof.

In the above example embodiment, the traffic signal 100 including the modules 101 to 109 has been described as an example of a multifunctional pole. In the present disclosure, the multifunctional pole is not limited to a traffic signal. Further, modules which can be incorporated into the multifunctional pole are not limited to the above-described modules 101 to 109. Examples of modules which can be used in the multifunctional pole may include a module for charging an electric vehicle, a module including a projector which projects light on to a road or surrounding structure, and a module including an illumination lamp. The modules which can be used in the multifunctional poles may include a module including a sensor. Examples of the sensor may include light detection and ranging (LiDAR) and a sensor for measuring a wind speed, an amount of rainfall, or a snow accumulation. The modules which can be used in the multifunctional poles may include a module including a beacon receiver. The multifunctional pole may be disposed, for example, in a park, a shopping center, and a store. The length of the multifunctional pole is not limited to any particular length, and may be any length within a range from a few meters to a dozen meters.

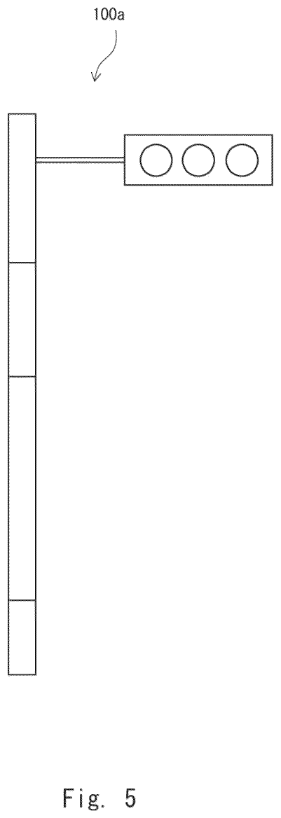

FIG. 5 shows a multifunctional pole according to a first modified example. In the example shown in FIG. 5, a traffic signal 100a includes the modules 101, 102, and 104 shown in FIG. 2B. The traffic signal 100a may include the module 103 for a traffic signal for pedestrians. Further, the traffic signal 100a may not include the module 102 for digital signage. In this case, a module for a height adjustment may be disposed at the position of the module 102 and coupled to other modules.

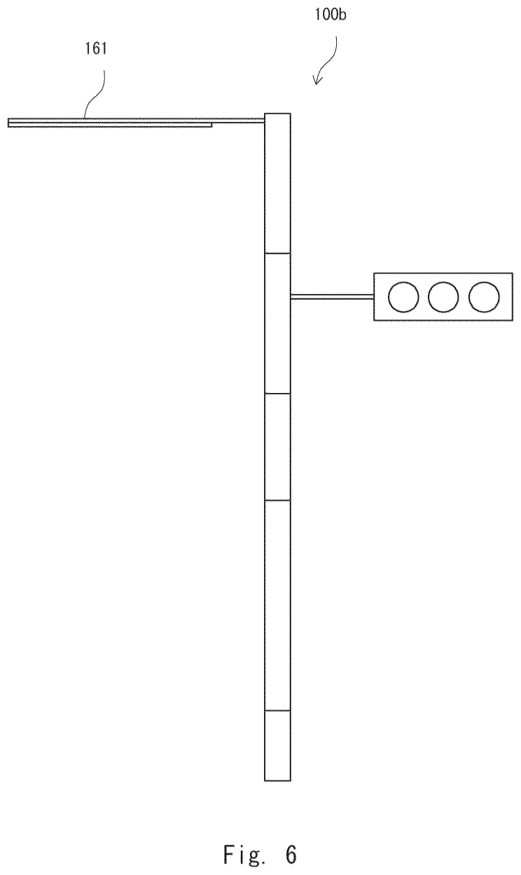

FIG. 6 shows a multifunctional pole according to a second modified example. In this example, a traffic signal 100b includes a module for illumination in addition to the modules 101 to 109 shown in FIG. 2B. The module for illumination includes an illumination lamp 161. In this example, an edge computer included in one of the modules may analyze a camera video image and control the illumination lamp in accordance with a result of the analysis. For example, the edge computer may illuminate the intersection brightly by turning on the illumination lamp 161 when there is a person near the traffic signal 100b. The edge computer may change the brightness and the color of the illumination lamp 161 in accordance with whether or not a person is near the traffic signal 100b.

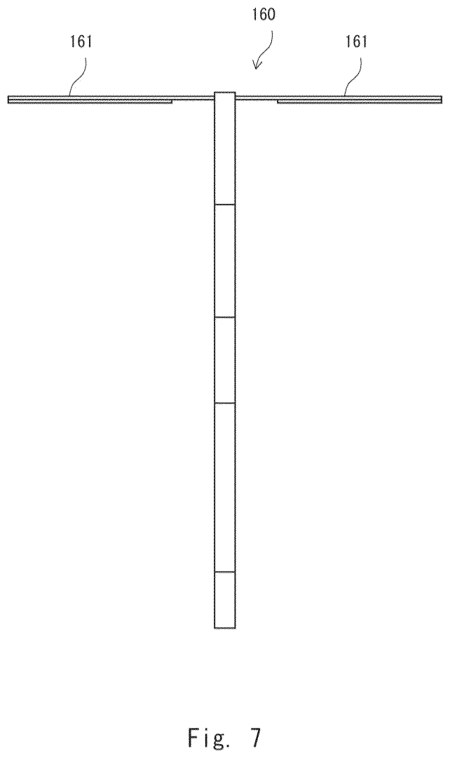

FIG. 7 shows a multifunctional pole according to a third modified example. In this example, a multifunctional pole 160 includes two illumination lamps 161. In the third modified example, the multifunctional pole 160 is used as a pole for illumination. In this example, similarly, the edge computer included in one of the modules may turn on the illumination lamps 161 to illuminate a place where the multifunctional pole 160 is installed when there is a person near the multifunctional pole 160. Further, the edge computer may change the brightness and the color of each of the illumination lamps 161 in accordance with whether or not a person is near the multifunctional pole 160.

Although the example embodiments according to the present disclosure have been described above in detail, the present disclosure is not limited to the above-described example embodiments. The present disclosure also includes those that are obtained by making changes or modifications to the above-described example embodiments without departing from the scope and spirit of the present disclosure.

For example, the whole or part of the example embodiments disclosed above can be described as, but not limited to, the following supplementary notes.

### Supplementary Note 1

A multifunctional pole including a plurality of units, each of the plurality of units having a predetermined function,
wherein the plurality of units are coupled to each other to form the pole.

### Supplementary Note 2

The multifunctional pole according to supplementary note 1, wherein
each of the plurality of units includes a first interface and a second interface, and
when a first unit is coupled to a second unit, the first interface of the first unit is connected to the second interface of the second unit.

### Supplementary Note 3

The multifunctional pole according to supplementary note 2, wherein each of the first interface and the second interface includes a power supply terminal configured to supply power.

### Supplementary Note 4

The multifunctional pole according to supplementary note 2 or 3, wherein each of the first interface and the second interface includes a communication terminal configured to perform signal communication.

### Supplementary Note 5

The multifunctional pole according to any one of supplementary notes 1 to 3, wherein the plurality of units include a unit including a traffic signal lighting device.

### Supplementary Note 6

The multifunctional pole according to supplementary note 5, wherein the plurality of units include a unit including a signal lighting device control circuit configured to control the traffic signal lighting device.

### Supplementary Note 7

The multifunctional pole according to any one of supplementary notes 1 to 6, wherein the plurality of units include at least one of a unit including an edge computer, a unit including a radio communication apparatus configured to perform radio communication with a radio communication terminal, a unit including a camera configured to capture an image of an area near the multifunctional pole, a unit including a sensor, and a unit including an illumination lamp.

### Supplementary Note 8

The multifunctional pole according to any one of supplementary notes 1 to 7, wherein the plurality of units include a unit including a power supply apparatus configured to supply power to the other units forming the pole.

### Supplementary Note 9

The multifunctional pole according to any one of supplementary notes 1 to 8, wherein a cross-sectional shape of the unit in a plane perpendicular to a longitudinal direction is elliptical or oblong.

### Supplementary Note 10

The multifunctional pole according to any one of supplementary notes 1 to 9, wherein respective thicknesses of the plurality of units are equal to each other.

### Supplementary Note 11

The multifunctional pole according to any one of supplementary notes 1 to 9, wherein the plurality of units include units having a plurality of thicknesses, and a unit having a first thickness is coupled to the pole so that the unit having the first thickness is positioned below a unit having a second thickness, the unit having the second thickness being thinner than the unit having the first thickness.

### REFERENCE SIGNS LIST

10: MULTIFUNCTIONAL POLE
11: UNIT
100: TRAFFIC SIGNAL
101-110: MODULE
120: MODULE
121: FIRST INTERFACE
122: SECOND INTERFACE
123: BODY
141: BODY
142: TRAFFIC SIGNAL LIGHTING DEVICE
143: COVER
144: ATTACHMENT TOOL
160: MULTIFUNCTIONAL POLE
161: ILLUMINATION LAMP

What is claimed is:

1. A multifunctional pole comprising a plurality of assemblies, each of the plurality of assemblies having a predetermined function,
wherein the plurality of assemblies are coupled to each other to form the pole.

2. The multifunctional pole according to claim 1, wherein
each of the plurality of assemblies comprises a first interface and a second interface, and
when a first assembly is coupled to a second assembly, the first interface of the first assembly is connected to the second interface of the second assembly.

3. The multifunctional pole according to claim 2, wherein each of the first interface and the second interface comprises a power supply terminal configured to supply power.

4. The multifunctional pole according to claim 2, wherein each of the first interface and the second interface comprises a communication terminal configured to perform signal communication.

5. The multifunctional pole according to claim 1, wherein the plurality of assemblies include an assembly comprising a traffic signal lighting device.

6. The multifunctional pole according to claim 5, wherein the plurality of assemblies include an assembly comprising a signal lighting device control circuit configured to control the traffic signal lighting device.

7. The multifunctional pole according to claim 1, wherein the plurality of assemblies include at least one of an assembly comprising an edge computer, an assembly comprising a radio communication apparatus configured to perform radio communication with a radio communication terminal, an assembly comprising a camera configured to capture an image of an area near the multifunctional pole, an assembly comprising a sensor, and an assembly comprising an illumination lamp.

8. The multifunctional pole according to claim 1, wherein the plurality of assemblies include an assembly comprising a power supply apparatus configured to supply power to the other units forming the pole.

9. The multifunctional pole according to claim 1, wherein a cross-sectional shape of the assembly in a plane perpendicular to a longitudinal direction is elliptical or oblong.

10. The multifunctional pole according to claim 1, wherein respective thicknesses of the plurality of assemblies are equal to each other.

11. The multifunctional pole according to claim 1, wherein the plurality of assemblies include assemblies having a plurality of thicknesses, and an assembly having a first thickness is coupled to the pole so that the assembly having the first thickness is positioned below an assembly having a second thickness, the assembly having the second thickness being thinner than the assembly having the first thickness.
